(19) United States
(12) Patent Application Publication
(10) Pub. No.: US 2013/0042974 A1
(43) Pub. Date: Feb. 21, 2013

(54) INSULATION MATERIAL AND METHOD FOR INSULATION

(71) Applicant: ContiTech Elastomer-Beschichtungen GmbH, Hannover (DE)

(72) Inventors: Sabine Luther, Hannover (DE); Heiko Eymer, Northeim (DE); Hans-Peter Paulsen, Goettingen (DE); Helge Zahel, Northeim (DE); Jens Storre, Noerten-Hardenberg (DE); Andreas Fleck, Garbsen (DE); Jens Loeschner, Bovenden (DE); Dagmar Henschel, Northeim (DE)

(73) Assignee: CONTITECH ELASTOMER-BESCHICHTUNGEN GMBH, Hannover (DE)

(21) Appl. No.: 13/653,166

(22) Filed: Oct. 16, 2012

Related U.S. Application Data
(63) Continuation of application No. PCT/EP2011/055998, filed on Apr. 15, 2011.

(30) Foreign Application Priority Data
Jun. 9, 2010 (DE) 10 2010 017 305.3

(51) Int. Cl. E04B 1/88; B32B 37/06

(52) U.S. Cl. 156/275.5; 252/62; 156/307.1

(57) ABSTRACT

A flexible insulation material in the form of sheets or strips, based on a rubber mixture of high thermal stability and a method for insulation of components with the insulation material. An insulation material proposed for use at temperatures of more than 130° C., which can be applied in a simple manner to complex components to be insulated and retains its desired shape and position, is one in which the rubber mixture is at least partially uncrosslinked and is plastically deformable. In the method, the insulation material comprising the at least partially uncrosslinked and plastically deformable rubber mixture is applied to the component to be insulated and, after the application, crosslinked or crosslinked further by thermal and/or radiative action.

### CROSS REFERENCE TO RELATED APPLICATIONS

This application is a continuation application of international patent application PCT/EP 2011/055998, filed Apr. 15, 2011, designating the United States and claiming priority from German application 10 2010 017 305.3, filed Jun. 9, 2010, and the entire content of both applications is incorporated herein by reference.

### FIELD OF THE INVENTION

The invention relates to a flexible sheet or strip insulation material based on a high-temperature-resistant rubber mixture. The invention further relates to a process for insulating components with the insulation material.

### BACKGROUND OF THE INVENTION

For the thermal and/or acoustic insulation of components, especially of components with complex geometries, only few solutions which are also usable at temperatures of more than 130° C. are available on the market. Typically, for insulation of components at these high temperatures, mineral wools are used, which are additionally provided with metal sheet or adhesive tape lamination and hence stabilized. Such insulation materials composed of laminated mineral wool have the following disadvantages: assembly and application to the component to be insulated and fixing are inconvenient and therefore costly. Complex components (moldings) can be insulated only with very great difficulty due to the low flexibility of the mineral wool. Mineral wools are absorptive, which, in the event of escape of or inadvertent wetting with liquids or formation of condensate, can lead under some circumstances to loss of the insulating action and, in the case of combustible liquids, for example oils, even to self-ignition. In the case of application of the mineral wool to the component to be insulated, fibers and/or fiber dust can also be released, which can lead to diseases in the respiratory organs in the case of prolonged exposure.

Alternative insulation materials based on polymers, for example self-expanding sealing tapes, are generally limited in terms of use temperature to ranges not exceeding 130° C.

GB 2 249 753 A describes a flexible sheet material for thermal insulation, for example, of hoses at extremely high temperatures, which comprises a ply of an unfoamed or foamed silicone rubber and a metal foil. Further fabric plies may be provided. The silicone rubber ply is always crosslinked prior to application to the component to be insulated. This involves applying the rubber ply, typically as a paste or solution, drying it and then crosslinking it. As a result of the prior crosslinking, the material generally no longer has any plastic deformability, since the crosslinking (vulcanization) causes the transition of the elastomer from the plastic to the elastic state. The material therefore cannot adjust optimally to very complex component geometries and the desired position is often not maintained.

### SUMMARY OF THE INVENTION

It is therefore an object of the invention to provide an insulation material for use at temperatures of more than 130° C., which is easy to apply to complex components to be insulated and maintains its desired shape and position. It is a further object of the invention to provide a simple and reliable process for insulating complex components at temperatures of more than 130° C.

This object is achieved in accordance with the invention by virtue of the rubber mixture of the insulation material being at least partly uncrosslinked and plastically deformable.

“Partially uncrosslinked” is understood to mean either a rubber mixture which comprises as yet unconsumed crosslinking chemicals or a rubber mixture which has been crosslinked with a small amount of crosslinking chemicals or none at all but still comprises at least crosslinkable polymer constituents.

By virtue of the rubber mixture comprising uncrosslinked and thus plastically deformable components or being completely uncrosslinked and plastically deformable, sheets or strips of the insulation material can be wound or placed around the components to be insulated and pressed on in a simple manner. The plastic deformability ensures that complex components, for example valves, heat exchangers or pipeline systems, can be insulated rapidly and in a lasting manner. The insulation material effectively nestles against the components. Application (assembly) is simple and hence inexpensive.

In addition, such an insulation material offers the advantages that it is not absorptive like mineral wool, for example, and application thereof does not release any mineral fibers or fiber dusts which are hazardous to health.

The use range at high temperatures is ensured by the use of a high-temperature-resistant rubber mixture.

The insulation material then serves to reduce heat losses to prevent burns when touched and for sound deadening. The insulation material can also be used for electrical insulation or as a fire protection coating.

In the process according to the invention, the insulation material comprising the at least partly uncrosslinked and plastically deformable rubber mixture is applied to the component to be insulated and, after application, crosslinked or crosslinked further by thermal and/or radiative action. The insulation material is thus still crosslinkable after application.

The subsequent crosslinking fixes the insulation material in its position with long-term stability, since the rubber mixture is converted from the plastic to the elastic state in the course of crosslinking.

In an advantageous development of the invention, the rubber mixture on application of the insulation material to the components to be insulated has such a high tack that the resilience forces of the insulation material do not lead to detachment of the material from the component surface. By virtue of its tack, the insulation material then remains on the surface to be insulated and also remains adhering to itself, and ensures simple fixing in the desired position.

In order to improve the thermal and acoustic insulation properties, it is advantageous when the rubber mixture has a pore structure. This pore structure can be effected by the use of chemical blowing agents or microspheres which are mixed into the rubber mixture. The blowing agents used may be either inorganic or organic compounds. The microspheres are hollow spheres having a diameter in the pm range made from glass, phenol resin, carbon or thermoplastic polymer material. They exist in expandable form, in which case they have been filled with a blowing agent and expand when heated, or in pre-expanded form; the expansion here is already complete. Such microspheres are sold, for example, under the Expancel® name by Akzo Nobel.

In a preferred development of the invention, for further improvement of the insulation properties, the rubber mixture of the insulation material may comprise as yet undecomposed chemical blowing agents. Blowing agents encapsulated in microspheres can also be used. These blowing agents offer—in addition to any pore structure already present—the possibility of forming pores after application to the material to be insulated. If blowing agents encapsulated in microspheres are used, these offer the advantage of formation of a closed pore structure which is of better suitability for insulation purposes due to lower convection in the pores.

According to a preferred process, the pores or the further pores can be formed by thermal and/or radiative action. The radiation may be IR radiation, microwaves or other high-energy radiation. Thermal action can be effected, for example, by heating with hot air from a hot air gun. A particularly simple and rapid process is one in which the thermal action and hence the formation of the pores are effected through the component to be insulated. The intrinsic heat of the component to be insulated triggers the chemical decomposition. The pores in this case are formed from the inside outward.

In order to further improve the process of formation of the pores after application to the component to be insulated and also to form a high number of pores in the outer region, it has been found to be advantageous when the rubber mixture comprises a substance of high thermal conductivity which vaporizes after application to the component to be insulated. First of all, this substance contributes to faster and better access of the heat from the component to the outer regions in order that pores can also be formed there, and then vaporizes in order that the insulating action is not impaired. The substance of high thermal conductivity used may, for example, be water or glycerol.

For robust processing, it is advantageous when the insulation material has high mechanical stability. This can prevent the insulation material from tearing on application. The mechanical stabilization can be effected by fillers or strengtheners. The strengtheners can be introduced into the rubber mixture in the form of short fibers. In a preferred development of the invention, the insulation material, however, comprises strengthener plies. These may be woven fabrics, loop-formed knitted fabrics or loop-drawn knitted fabrics which permit a certain degree of extension.

Useful materials for the strengtheners include, for example, glass, cotton, polyamide or aramid.

For further improvement of the insulation material, further layers and/or plies may be provided. For instance, to reduce the level of emissions, a metal foil can be applied by doubling. Specific varnish layers can also be applied for this purpose.

The insulation material is based on a high-temperature-resistant rubber mixture. The rubbers used may, for example, be silicone rubber, hydrogenated nitrile rubber (HNBR), fluoro rubber, acrylate rubber, ethylene-acrylate co- and terpolymers, ethylene-propylene-diene rubber, epichlorohydrin rubber and blends thereof. The rubber mixture is preferably based on silicone rubber because this rubber has particularly high thermal stability and plastic deformability, and a certain degree of tack. Preference is given to HTV types which may be either peroxidically crosslinkable or addition-crosslinkable.

In an advantageous development of the invention, the rubber mixture for the insulation material comprises 2 to 12 phr of expanded microspheres. In this way, the insulation material receives an adequate pore structure for good thermal and acoustic insulation. Expanded microspheres offer the advantage over conventional chemical blowing agents that they bring about a homogeneous, closed-pore cell structure. The higher the amount of expanded microspheres, the better the insulating action will be as a result of the higher pore content. In the case of excessive amounts of microspheres, however, processing problems can arise in the mixture production and the insulation material loses strength, which is disadvantageous on application to the components to be insulated. The insulation material can then tear easily.

The inventive insulation material can be produced by processes known to those skilled in the art, with initial production of a rubber mixture with all required additives and subsequent calendering of the mixture to give sheets, optional lamination with further plies and optional cutting into strips.

### DESCRIPTION OF THE PREFERRED EMBODIMENTS OF THE INVENTION

A working example will illustrate the invention in detail, without restricting the invention thereto.

A silicone rubber-based rubber mixture with the composition shown in Table 1 was produced. The right-hand column of the table states the possible ranges of amounts for a silicone rubber mixture. The unit phr (parts per hundred parts of rubber by weight) used in this document is the unit of amount customary in the rubber industry for mixture formulations. The dosage of the parts by weight of the individual substances is always based on 100 parts by weight of the overall composition of all rubbers present in the mixture.

TABLE 1

| | | Possible amount |
|---|---|---|
| Substance | Amount in phr | ranges in phr |
| Silicone rubber^{a} | 100 | 100 |
| Heat stabilizers | 1.95 | 0 - 6 |
| Processing aids | 0.3 | 0 - 3 |
| Peroxide crosslinkers | 1.05 | 0.3 - 4 |
| Silicone oil | 9.30 | 2 - 20 |
| Pre-expanded microspheres^{b} | 5.58 | 2 - 12 |
| Chemical blowing agents | — | 0 - 10 |
| Expandable microspheres^{c} | 1.5 | 0 - 10 |
| Other additives (e.g. flame | — | 0 - 12 |
| retardants, conductive fillers) | | |

^{a}Elastosil ® R 420/50 S, Wacker Chemie AG, Germany
^{b}Expancel ® 920 DE 40 d30, Akzo Nobel N.V., the Netherlands
^{c}Expancel ® 920 DU 80, Akzo Nobel N.V., the Netherlands

The mixture was calendered to give sheets of thickness approximately 3 mm. The material features a homogeneous closed pore structure through the use of the pre-expanded microspheres. It shows a thermal conductivity of approximately 0.1 W/(m*K) and therefore has good insulation properties. The tack, measured with a tackiness meter, is 2 N.

The insulation material was cut into strips and used to double-wrap various test valves, pipelines with T-pieces and 90° curves, and also flexible hose connections for insulation, with a slight overlap. By virtue of its plastic deformability, the insulation material had good processability and applicability to the components to be insulated. By virtue of the tack, it had good adhesion to the individual components. Thermal oil at 200° C. flowed through the components. In the course of this, the expansion of the further expandable microspheres formed further pores and the silicone rubber mixture crosslinked peroxidically. Temperature measurements on the outside of the insulation material after flow of liquid at 200° C. for 24 hours showed an outside temperature of approximately 70° C. This corresponds to an energy saving of approximately 70%. The insulation material offers excellent thermal and acoustic insulation, even at temperatures of more than 130° C.

It is understood that the foregoing description is that of the preferred embodiments of the invention and that various changes and modifications may be made thereto without departing from the spirit and scope of the invention as defined in the appended claims.

What is claimed is:

1. A flexible sheet or strip insulation material based on a high-temperature-resistant rubber mixture, wherein the rubber mixture of the insulation material is at least partly uncrosslinked and plastically deformable.

2. The insulation material as claimed in claim 1, wherein the rubber mixture on application of the insulation material to the components to be insulated has such a high tack that the resilience forces of the insulation material do not lead to detachment of the material from the component surface.

3. The insulation material as claimed in claim 1, wherein the rubber mixture has a pore structure.

4. The insulation material as claimed in claim 1, wherein the rubber mixture comprises as yet undecomposed chemical blowing agents.

5. The insulation material as claimed in claim 1, wherein the rubber mixture comprises blowing agents encapsulated in microspheres.

6. The insulation material as claimed in claim 1, wherein the rubber mixture comprises a substance of high thermal conductivity which vaporizes after application to the component to be insulated.

7. The insulation material as claimed in claim 1, further comprising strengthener plies.

8. The insulation material as claimed in claim 1, wherein the rubber mixture is based on silicone rubber.

9. The insulation material as claimed in claim 1, wherein the rubber mixture comprises 2 to 12 phr of expanded microspheres.

10. A process for insulating components with the insulation material as claimed in claim 1, comprising: applying the insulation material including the at least partly uncrosslinked and plastically deformable rubber mixture to the component to be insulated and, after application, crosslinking or further crosslinking the at least partly uncrosslinked and plastically deformable rubber mixture by thermal action, radiative action or thermal and radiative action.

11. The process as claimed in claim 10, further comprising forming pores by the thermal action, radiative action or thermal and radiative action following the application of the insulation material.

12. The process as claimed in claim 10, wherein the thermal action is effected through the component to be insulated.
